(19) United States
(12) Patent Application Publication
(10) Pub. No.: US 2004/0025296 A1
(43) Pub. Date: Feb. 12, 2004

(54) Hinge

(75) Inventor: Allen P. Wade, Prophetstown, IL (US)

Correspondence Address: WOOD, PHILLIPS, KATZ, CLARK & MORTIMER, 500 W. MADISON STREET, SUITE 3800, CHICAGO, IL, 60661, US

(73) Assignee: Lawrence Hardware, LLC

(21) Appl. No.: 10/215,827

(22) Filed: Aug. 9, 2002

(51) Int. Cl. E05D 11/00

(52) U.S. Cl. 16/273

(57) ABSTRACT

A hinge having first and second plates with mating knuckles, the knuckle of the second plate having a greater inner diameter than that of the first plate. A bushing in the knuckle of the second hinge plate has a body with an inner diameter matching the inner diameter of the knuckle of the first plate, to receive a hinge pin. The bushing body has a flange with an outer end surface forming a bearing with the end surface of the knuckle of the first hinge plate. The bushings are of a sintered bronze including graphite.

### BACKGROUND OF THE INVENTION

This invention is concerned with a hinge, particularly a door hinge, in which wear and noise from rubbing or binding surfaces are minimal and which can be manufactured without expensive machining of the parts.

A typical door hinge has two plates or leaves with complimentary knuckles, which are joined by a pin. Metal to metal joints between the ends of the knuckles and between the knuckles and pin often bind, making the hinge hard to move and causing irritating squeaks or other noise. Plastic bushings have been proposed by Parsons U.S. Pat. No. 3,499,183 and Suska U.S. Pat. No. 3,921,225. However, the hinges of both Parsons and Suska require expensive counterbores in the hinge knuckles or machining of other hinge components.

### BRIEF SUMMARY OF THE INVENTION

This invention is concerned with a hinge which minimizes friction and noise but does not require machining of the hinge components.

One feature of the hinge is that it comprises a first hinge plate with a knuckle of a first inner diameter, a second hinge plate with a knuckle having an inner diameter greater than that of the first hinge plate, a bearing bushing in the knuckle of the second hinge plate having a body with an outer diameter substantially equal to the inner diameter of the knuckle of the second hinge plate, a bore with an inner diameter substantially equal to the inner diameter of the knuckle of the first hinge plate and a flange with an outer end surface forming a bearing with the end surface of the knuckle of the first hinge plate and an inner surface bearing against the end surface of the knuckle of the second hinge plate, and a hinge pin extending through the knuckles of both hinge plates and through the bushing. Another feature of the invention is that the knuckle of the second hinge plate is free of counterbores.

A further feature of the hinge is that the bushing is sintered bronze, preferably including graphite.

Another feature is that the bushing flange is tapered axially of the bushing between an outer end surface corresponding in diameter to the end surface of the knuckle of the first hinge plate and an inner surface corresponding in diameter with the end surface of the knuckle of the second hinge plate. Preferably the bushing flange outer surface has an outer diameter less than the outer diameter of the end of the knuckle of the first hinge plate; and the bushing flange inner surface has an outer diameter less than the outer diameter of the end of the knuckle of the second hinge plate.

And a further feature is that the flange of the bushing is undercut so that the bushing flange seats on the end surface of the knuckle of the second hinge plate without impinging on material that is axially extruded during formation of the knuckle.

### BRIEF DESCRIPTION OF THE SEVERAL VIEWS OF THE DRAWING

Further features and advantages will be apparent from the following description and the drawings in which:

FIG. 1 is an elevation of an open hinge embodying the invention, with the hinge knuckles shown in section; and

FIG. 2 is an enlarged fragmentary section of adjacent ends of the hinge plate knuckles and the bearing bushing as indicated at FIG. 2 of FIG. 1.

### DETAILED DESCRIPTION OF THE INVENTION

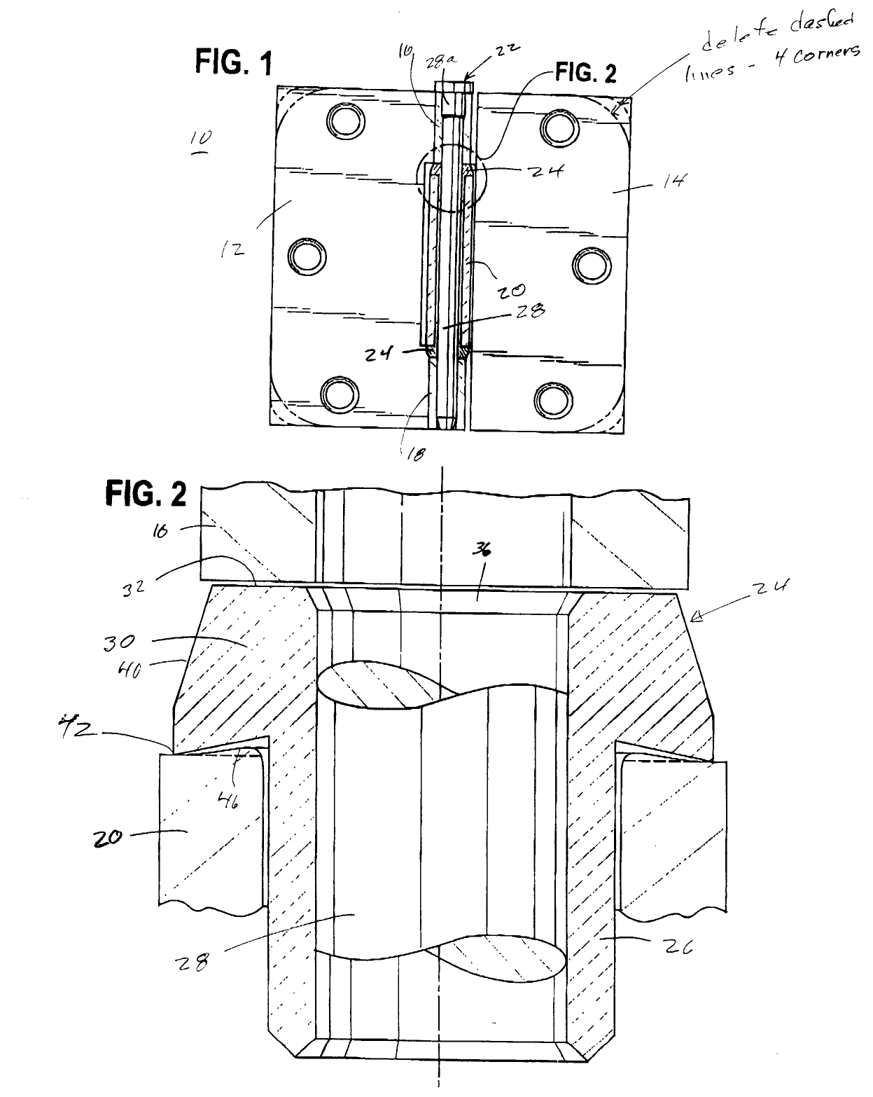

The hinge pin, FIG. 1, has two plates or leaves, a first or frame plate 12 and a second or center plate 14. Frame plate 12 has spaced apart upper and lower knuckles 16 and 18, respectively. Second plate 14 has a centrally located single knuckle 20 which fits between and mates with knuckles 16 and 18. Hinge pin 22 extends through the three knuckles and joins the two hinge plates. Knuckles 16, 18, and 20 are typically formed by rolling from the flat stock of the plate.

Center knuckle 20 has a larger diameter than hinge knuckles 16, 18. Bushings 24, one at each end of center knuckle 20, provide bearing surfaces for the hinge, as will be described.

Bushing 24 has a cylindrical body 26 with an outer diameter to match the inner diameter of knuckle 20 and an inner diameter to receive the shank 28 of hinge pin 22. Bushing flange 30 provides a bearing between adjacent ends of knuckles 16 and 20. The shank 28 of pin 22 is spaced from the inner surface of knuckle 20 by the bodies 26 of bushings 24.

Bushings 24 are preferably fabricated of sintered bronze with 1% graphite to provide a low coefficient of friction and quiet operation. The upper and lower bushings are identical and will be described with reference to FIG. 2. The outer end surface 32 of the bushing flange 30 provides a bearing surface with the end surface of adjacent knuckle 16. The outer diameter of the end surface of flange 30 is slightly less than the outer diameter of the end surface of knuckle 16 and the inner edge of bore through bushing 24 has a chamfer 36 so that the outer end bearing surface 32 is smaller than the end surface of knuckle 16. Bushing end bearing surface 32 has an area of contact with the end surface of knuckle 16 which is centered on the knuckle end surface is spaced from the edges of the knuckle end surface.

The lateral surface 40 of flange 30 is tapered from the outer end 32 to inner edge 42 which rests on the end of center knuckle 20. The diameter of the inner end 42 of flange 30 is slightly less than the outer diameter of knuckle 20 so that the area of contact of the bushing flange with the knuckle is spaced from the edge of the end face of the knuckle.

In forming the center knuckle, as by rolling from flat stock, metal is extruded axially around the inner edge of the knuckle end face, resulting in a bulge 46. Flange 30 is undercut, as at an angle of the order of 11 degrees, to avoid impinging on the bulge of extruded material and ensuring that the inner flange edge 42 seats on the end of knuckle 20.

Hinge pin 22 is fixed with knuckle 16 of frame plate 12 by an enlarged section 28a of shank 28. In opening and closing a door mounted on hinge 10, hinge pin 22 is fixed with frame plate 12 and bushings 24 are fixed with center plate 14. Rotation with an axial thrust load occurs between the end of knuckle 16 and the outer end surface 32 of bushing flange 30. Rotation with a lateral load occurs between the inner surfaces of bushings 24 and the shank 28 of hinge pin 22. The downward component of the weight of the door is transferred from the knuckle 20 through the flange of lower bushing 24 to knuckle 18. The graphite treated sintered bronze material of the bushings ensures low friction and noise free operation of the hinge.

One embodiment of the hinge of 0.084 inch stock has the following nominal dimensions:

| | | |
|---|---|---|
| Inner diameter of knuckles 16, 18 and of bushing 24 | 0.194 | inch |
| Outer diameter of knuckle 16, 18 | 0.362 | inch |
| Outer diameter of bushing end surface 32 | 0.350 | inch |
| Diameter of inner end 42 of bushing flange 30 | 0.412 | inch |
| Inner diameter of knuckle 20 | 0.254 | inch |
| Outer diameter of knuckle 20 | 0.422 | inch |
| Diameter of hinge pin shank 28 | 0.189 | inch |
| Diameter of enlarged pin shank section 28a | 0.202 | inch |
| Undercut of bushing flange | 11 | degrees |

The hinge is shown with two frame plate knuckles and one center plate knuckle. The novel bushing construction can be used in a hinge with additional knuckles, as three knuckles on the frame plate and two knuckles on the center plate. Conversely, the novel bushing can be used where one plate mounted on a door has a fixed pin extending downwardly from an axial bearing surface corresponding with the end surface of a knuckle. The other plate has a knuckle with an inner dimension greater than the pin diameter. An upper bushing in the knuckle receives the pin and provides both thrust and lateral bearing surfaces. An optional second bushing in the lower end of the knuckle provides an additional lateral bearing surface.

I claim:

1. A door hinge comprising:
a first hinge plate with a knuckle of a first inner diameter;
a second hinge plate to mate with said first hinge plate, with a knuckle of a second inner diameter, greater than said first inner diameter;
a bushing in the knuckle of the second hinge plate, the bushing having a body with an outer diameter substantially equal to said second inner diameter and a bore with an inner diameter substantially equal to said first inner diameter, the bushing having a flange with an outer end surface forming a bearing with the end surface of the knuckle of the first hinge plate and an inner surface forming a bearing with the end surface of the knuckle of the second hinge plate; and
a hinge pin extending through the knuckles of both hinge plates and through the bushing.

2. The hinge of claim 1 in which the knuckle of the second hinge plate is free of counterbores.

3. The hinge of claim 1 in which the bushing flange is tapered axially of the bushing between the outer end surface corresponding in diameter with the end surface of the knuckle of the first hinge plate and the inner surface corresponding in diameter with the end surface of the knuckle of the second hinge plate.

4. The hinge of claim 1 in which the bushing flange outer end surface is flat for rotary, sliding engagement with the end surface of the knuckle of the first hinge plate.

5. The hinge of claim 3 in which the bushing flange outer end surface has an outer diameter less than the outer diameter of the end of the knuckle of the first hinge plate.

6. The hinge of claim 3 in which the bushing flange inner surface has an outer diameter less than the outer diameter of the end of the knuckle of the second hinge plate.

7. The hinge of claim 1 in which the end surface of the knuckle of the second hinge plate is subject to an axial extrusion of material around its inner diameter in the formation of the knuckle, and the flange of the bushing is undercut to allow the bushing flange to seat on the end surface without impinging on said axially extruded material.

8. The hinge of claim 7 in which the undercut of the flange of each bushing is at an angle from the flange periphery toward the bushing body.

9. The hinge of claim 1 in which the bushing is sintered bronze.

10. The hinge of claim 9 in which said sintered bronze bushing includes graphite.

11. The hinge of claim 10 in which the graphite content of said sintered bronze bushing is of the order of 1%.

12. A door hinge comprising:
a first hinge plate with spaced apart, axially aligned knuckles of a first inner diameter;
a second hinge plate to mate with the first hinge plate, with a center knuckle to fit between the knuckles of the first hinge plate having an inner diameter greater than said first inner diameter;
a bushing in each end of the knuckle of the second hinge plate, each bushing having a body of an outer diameter substantially equal to said second inner diameter and bore with an inner diameter substantially equal to said first inner diameter, each bushing having a flange with an outer end surface forming a bearing with the adjacent end surface of the knuckles of the first hinge plate and an inner surface forming a bearing with the end surfaces of the knuckle of the second hinge plate; and
a hinge pin extending through the knuckles of both hinge plates and through the bushings.

13. The hinge of claim 12 in which the knuckle of the second hinge plate is free of counterbores.

14. The hinge of claim 12 in which the bushing flange of each bushing is tapered axially of the bushing between the outer end surface corresponding in diameter with the end surface of the adjacent knuckle of the first hinge plate and the inner surface corresponding in diameter with the end surface of the knuckle of the second hinge plate.

15. The hinge of claim 12 in which the bushing flange outer end surface is flat for rotary, sliding engagement with the end surface of the adjacent knuckle of the first hinge plate.

16. The hinge of claim 14 in which the bushing flange outer end surface has an outer diameter less than the outer diameter of the end of the adjacent knuckle of the first hinge plate.

17. The hinge of claim 14 in which the bushing flange inner surface has an outer diameter less than the outer diameter of the end of the knuckle of the second hinge plate.

18. The hinge of claim 12 in which the end surfaces of the knuckle of the second hinge plate are subject to an axial extrusion of material around the knuckle's inner diameter in the formation of the knuckle, and the flange of each bushing is undercut to allow each bushing flange to seat on the knuckle end surface without impinging on said axially extruded material.

19. A door hinge comprising:
a first hinge plate with an axial bearing surface and a pin of a first diameter extending downwardly therefrom;
a second hinge plate to mate with the first hinge plate, with a knuckle of an inner diameter greater than said pin diameter; and
a bushing in the knuckle of the second hinge plate, the bushing having a body with an outer diameter substantially equal to said knuckle inner diameter and a bore with an inner diameter substantially equal to said pin diameter, the bushing having a flange with an outer end surface forming a bearing with the axial bearing surface of the first hinge plate and an inner surface forming a bearing with the end surface of the knuckle of the second hinge plate.
